(19) United States
(12) Patent Application Publication
(10) Pub. No.: US 2026/0277160 A1
(43) Pub. Date: Sep. 17, 2026

(54) TEMPERATURE COMPENSATION-TYPE BALANCE WITH HAIRSPRING, MOVEMENT, AND TIMEPIECE

(71) Applicant: SEIKO WATCH KABUSHIKI KAISHA (trading as SEIKO WATCH CORPORATION), Tokyo (JP)

(72) Inventors: Kazuki HAYAKAWA, Tokyo (JP); Kengo ITO, Tokyo (JP); Hisashi FUJIEDA, Tokyo (JP)

(21) Appl. No.: 19/548,049

(22) Filed: Feb. 24, 2026

(30) Foreign Application Priority Data
Mar. 17, 2025 (JP) 2025-042356

(51) Int. Cl. G04B 17/22; G04B 17/06

(52) U.S. Cl. CPC G04B 17/222; G04B 17/06

(57) ABSTRACT

To provide a temperature compensation-type balance with hairspring capable of reducing deformation of a bimetal portion and improving temperature compensation performance. A temperature compensation-type balance with hairspring includes a balance with hairspring main body, adjustment portions, and a regulation portion. The balance with hairspring main body includes a balance staff extending along a first axis and rotates around the first axis. The adjustment portions are supported as a cantilever along the second axis from rotationally symmetrical positions around the first axis in the balance with hairspring main body, each of the adjustment portions including a bimetal portion in which materials having different thermal expansion coefficients are stacked in a direction intersecting the second axis. The regulation portion is provided at a position corresponding to a free end of the adjustment portion and regulates movement of the adjustment portion with a gap of 0 mm or more relative to a movement range of the bimetal portion at a use temperature.

### RELATED APPLICATIONS

This application claims priority to Japanese Patent application No. JP2025-042356 filed on Mar. 17, 2025, the entire content of which is incorporated herein by reference.

### BACKGROUND OF THE INVENTION

### 1. Field of the Invention

The present invention relates to a temperature compensation-type balance with hairspring, movement, and timepiece.

### 2. Description of the Related Art

In the related art, a configuration of a balance with hairspring including a balance staff extending along an axis, a balance wheel fixed to the balance staff, and a hairspring and functioning as a speed governor for a mechanical timepiece has been disclosed. In the balance with hairspring, various techniques for reducing a change in a rate (a degree to which the timepiece is slow or fast) of the mechanical timepiece due to a temperature change have been proposed.

For example, JP6275299B discloses a configuration of a temperature compensation-type balance with hairspring including a bimetal unit having two types of members having different expansion coefficients inside the balance with hairspring. One end of the bimetal unit is fixed to a spoke portion of a balance wheel, and the other end is a free end. According to the technique disclosed in JP6275299B, it is possible to achieve a temperature compensation function of reducing the influence of temperature fluctuation by changing a bend of the bimetal unit according to the temperature change. It is said that a correction amount can be increased by providing a weight at the other end portion (tip portion on a free end side) of the bimetal unit.

However, in the technique described in JP6275299B, since the bimetal unit has a cantilever structure, when an impact is applied due to falling of a timepiece or the like, stress is applied to a fixing portion (base end portion) of the bimetal unit, and the bimetal unit may be deformed. When the bimetal unit is deformed, correct temperature compensation cannot be performed, and the rate of the timepiece may shift.

As a countermeasure against the impact as described above, for example, it is conceivable to reduce the weight of the weight provided at the free end or to increase strength of bimetal itself. However, when the weight is reduced, a correction amount becomes small, and there is a possibility that sufficient correction cannot be performed with respect to a temperature change. When the strength of the bimetal itself is increased by strengthening a structure, the weight of the balance with hairspring with respect to a moment of inertia of the balance with hairspring increases, and there is a possibility that an adverse effect such as difference in rate between horizontal and vertical positions occurring.

Therefore, the related art has a problem in that deformation of the bimetal portion is reduced and temperature compensation performance is improved in the temperature compensation-type balance with hairspring.

### SUMMARY OF THE INVENTION

It is an aspect of the present application to provide a temperature compensation-type balance with hairspring capable of reducing deformation of a bimetal portion and improving temperature compensation performance, and a movement and a timepiece including the temperature compensation-type balance with hairspring.

In order to solve the above problem, a temperature compensation-type balance with hairspring according to one aspect of the application includes: a balance with hairspring main body including a balance staff extending along a first axis and rotating around the first axis by power of a hairspring; adjustment portions that are supported as a cantilever along a second axis from rotationally symmetrical positions around the first axis in the balance with hairspring main body, each of the adjustment portions including a bimetal portion in which materials having different thermal expansion coefficients are stacked in a direction intersecting the second axis; and a regulation portion that is provided at a position corresponding to a free end of the adjustment portion and regulates movement of the adjustment portion with a gap of 0 mm or more relative to a movement range of the bimetal portion at a predetermined use temperature.

According to this aspect, the bimetal portion of the adjustment portion is deformed according to a temperature change, and thus the average diameter of the balance with hairspring main body is changed. Accordingly, a temperature characteristic of a moment of inertia can be corrected. As a result, a vibration period of the balance with hairspring can be kept constant, and the balance with hairspring having an excellent temperature compensation characteristic can be obtained. Since the adjustment portion extends in a cantilever manner, a deformation amount in a radial direction due to a temperature change can be secured, and a temperature correction amount by the bimetal portion can be increased.

The regulation portion is provided at a position corresponding to the free end of the adjustment portion. Accordingly, even when an impact is applied to the balance with hairspring due to falling or the like, since movement of the free end of the adjustment portion is limited by the regulation portion, it is possible to reduce deformation of the bimetal portion. As a result, as compared with the related art, it is possible to perform correct temperature compensation even when an impact is applied, and to reduce the rate shift of a timepiece. Since it is not necessary to reduce the weight as a countermeasure against an impact, there is no restriction on the weight of the weight, and a large temperature correction amount can be secured. Further, since it is not necessary to increase strength of the bimetal portion as a countermeasure against an impact, restrictions (Young's modulus, allowable stress, and the like) on bimetal material are reduced, and a degree of freedom in material selection can be improved. In other words, design can be performed in consideration of only an expansion coefficient. Therefore, it is possible to provide highly accurate temperature compensation performance. Since the weight of the balance with hairspring is reduced as compared with the case where the strength of the bimetal portion is increased, it is possible to reduce occurrence of difference in rate between horizontal and vertical positions.

Therefore, it is possible to provide the temperature compensation-type balance with hairspring capable of reducing deformation of the bimetal portion and improving the temperature compensation performance.

In the temperature compensation-type balance with hairspring, the balance with hairspring main body includes the balance staff, and a balance wheel including a rim portion surrounding the balance staff from an outer side in a radial direction of the first axis and attached to the balance staff, the second axis is a straight line intersecting the rim portion in a plan view viewed from the first axis, and the adjustment portion extends from the rim portion to an inner side of the rim portion.

According to this aspect, since the adjustment portion is provided on the rim portion of the balance wheel, the adjustment portion can be separated from the first axis in the radial direction. Accordingly, it is possible to increase the deformation amount of the adjustment portion along the radial direction, and it is possible to increase a temperature coefficient correction amount by the bimetal portion. Since the second axis is located inside the rim portion, it is possible to secure the deformation amount along the radial direction due to the temperature change while reducing an increase in size of the balance with hairspring due to addition of the adjustment portion.

In the temperature compensation-type balance with hairspring, the regulation portion includes a free end insertion portion which is formed along the second axis in the rim portion and into which the free end of the adjustment portion is inserted.

According to this aspect, since the regulation portion is provided in the rim portion, it is possible to reduce an increase in the number of components and an increase in the weight of the balance with hairspring due to provision of the regulation portion. Movement of the free end of the adjustment portion can be regulated by inserting the free end of the adjustment portion into the free end insertion portion formed in the rim portion. Therefore, deformation of the adjustment portion at the time of impact can be reduced with a simple configuration.

In the temperature compensation-type balance with hairspring, the rim portion has an attachment hole for fixing one end portion of the adjustment portion and is formed such that an inner diameter dimension of the attachment hole and an inner diameter dimension of the free end insertion portion are the same.

According to this aspect, the attachment hole and the free end insertion portion formed in the rim portion can be simultaneously formed. Alternatively, the attachment hole and the free end insertion portion can be formed by the same tool. Therefore, workability at the time of manufacturing can be improved.

In the temperature compensation-type balance with hairspring, the adjustment portion includes a weight attached to a free end side of the bimetal portion, the weight includes a main body portion attached to the bimetal portion and a tip portion having an outer diameter dimension smaller than an outer diameter dimension of the main body portion, and the tip portion of the weight is inserted into the free end insertion portion of the regulation portion.

According to this aspect, since the weight of the adjustment portion can be increased by providing the weight, the temperature correction amount by the bimetal portion can be increased. Since the tip portion of the weight having a small outer diameter dimension is inserted into the free end insertion portion, the inner diameter dimension of the free end insertion portion can be reduced. Therefore, particularly when the free end insertion portion is formed in the rim portion, it is possible to achieve excellent temperature compensation performance while reducing a decrease in strength of the rim portion.

In the temperature compensation-type balance with hairspring, the regulation portion is formed to have a gap having a size corresponding to a predetermined temperature change of 0° C. or higher and 30° C. or lower with respect to the predetermined use temperature, or to have a gap having a size of 0 mm or more and 0.1 mm or less relative to the movement range of the bimetal portion at the predetermined use temperature.

According to this aspect, the size of the gap can be appropriately set with respect to a swing width of the adjustment portion at an assumed use temperature. Therefore, it is possible to effectively achieve temperature compensation performance while reducing deformation when an impact occurs.

In the temperature compensation-type balance with hairspring, the adjustment portion has a recess recessed along the second axis at an end portion on a free end side, and the regulation portion includes a protrusion portion inserted into the recess.

According to this aspect, since the regulation portion can be provided without forming a hole, a recess, or the like in the balance with hairspring, it is possible to reduce a decrease in strength of the balance with hairspring due to the provision of the regulation portion. Therefore, it is possible to reduce a decrease in strength of the balance with hairspring and deformation of the bimetal portion and to improve the temperature compensation performance.

In the temperature compensation-type balance with hairspring, the regulation portion includes a pair of wall portions that are connected to the balance with hairspring main body and regulate movement of the free end in the adjustment portion in a vertical direction parallel to the first axis.

According to this aspect, since movement of the free end of the adjustment portion in the vertical direction (a direction along an axial direction of the first axis) is limited by the pair of wall portions, deformation of the bimetal portion at the time of impact can be reduced. Therefore, it is possible to provide the temperature compensation-type balance with hairspring capable of reducing deformation of the bimetal portion and improving the temperature compensation performance. Moreover, versatility of the regulation portion can be enhanced.

In the temperature compensation-type balance with hairspring, the regulation portion includes a pair of wall portions that are connected to the balance with hairspring main body and regulate movement of the free end in the adjustment portion in a radial direction intersecting the first axis.

According to this aspect, since movement of the free end of the adjustment portion in a left-right direction (a direction along a radial direction of the first axis) is limited by the pair of wall portions, deformation of the bimetal portion at the time of impact can be reduced. Therefore, it is possible to provide the temperature compensation-type balance with hairspring capable of reducing deformation of the bimetal portion and improving the temperature compensation performance. Moreover, versatility of the regulation portion can be enhanced.

In the temperature compensation-type balance with hairspring, the balance with hairspring main body includes the balance staff, and a balance wheel including a rim portion surrounding the balance staff from an outer side in a radial direction of the first axis and a spoke portion connecting the balance staff and the rim portion and extending in the radial direction, the second axis is a curve along the rim portion, and the rim portion is the bimetal portion.

According to this aspect, since the rim portion and the bimetal portion (adjustment portion) are integrated, a simpler configuration can be obtained.

In the temperature compensation-type balance with hairspring, the regulation portion is attached to the spoke portion and regulates movement of the free end in the radial direction.

According to this aspect, even when an impact is applied to the balance with hairspring due to falling or the like, since movement of the free end of the adjustment portion is limited by the regulation portion, it is possible to reduce deformation of the bimetal portion. Therefore, it is possible to perform correct temperature compensation even when an impact is applied, and to reduce a rate shift of the timepiece. Therefore, it is possible to provide the temperature compensation-type balance with hairspring capable of reducing deformation of the bimetal portion and improving the temperature compensation performance.

A movement according to an aspect of the application includes the temperature compensation-type balance with hairspring.

According to this aspect, since the temperature compensation-type balance with hairspring according to the above aspect is provided, it is possible to provide the high-performance movement including the temperature compensation-type balance with hairspring capable of reducing deformation of the bimetal portion and improving the temperature compensation performance.

A timepiece according to an aspect of the application includes the movement described above.

According to this aspect, since the movement according to the above aspect is provided, it is possible to provide the high-performance timepiece including the temperature compensation-type balance with hairspring capable of reducing deformation of the bimetal portion and improving the temperature compensation performance.

According to the application, it is possible to provide a temperature compensation-type balance with hairspring capable of reducing deformation of a bimetal portion and improving temperature compensation performance, and a movement and a timepiece including the temperature compensation-type balance with hairspring.

### BRIEF DESCRIPTION OF THE DRAWINGS

FIG. 1 is an external view of a timepiece according to a first embodiment.

FIG. 2 is a plan view of a movement according to the first embodiment when viewed from the front side.

FIG. 3 is a plan view of a balance with hairspring according to the first embodiment viewed from the front side.

FIG. 4 is an enlarged view of portion IV in FIG. 3.

FIG. 5 is a cross-sectional view taken along line V-V in FIG. 3.

FIG. 6 is a cross-sectional view of a balance with hairspring according to a second embodiment.

FIG. 7 is an external perspective view of a balance with hairspring according to a third embodiment.

FIG. 8 is an external perspective view of a balance with hairspring according to a fourth embodiment.

FIG. 9 is an external perspective view of a balance with hairspring according to a fifth embodiment.

### DETAILED DESCRIPTION OF THE PREFERRED EMBODIMENTS

Hereinafter, embodiments of the invention will be described with reference to drawings. In the following description, configurations having the same or similar functions are denoted by the same reference signs. A duplicate description of these configurations may be omitted. In the following drawings, in order to make the drawings easier to see, some of timepiece components may be omitted, and the timepiece components may be illustrated in a simplified manner.

### First Embodiment

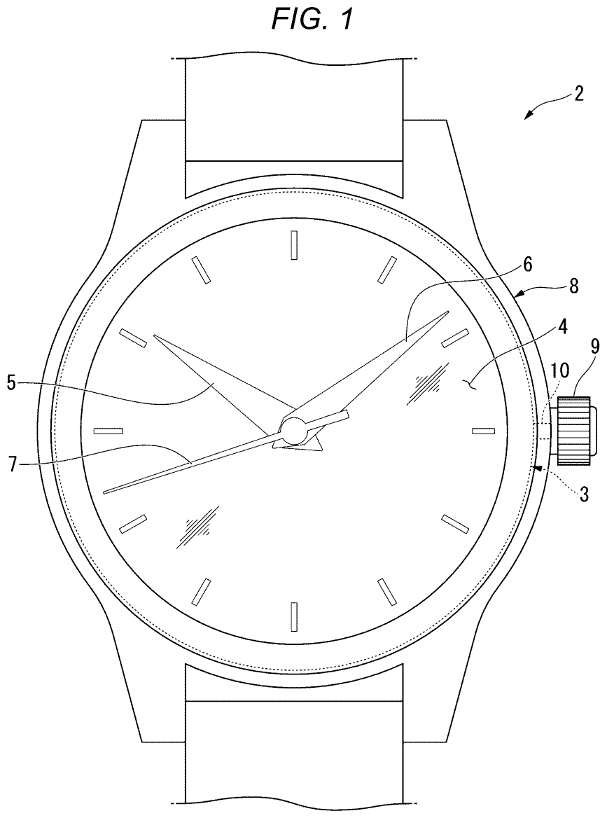

FIG. 1 is an external view of a timepiece 2 according to the first embodiment.

The timepiece 2 is implemented by incorporating a movement 3, a dial 4, various hands 5 to 7, and the like in a timepiece case 8.

The timepiece case 8 includes a case main body, a case cover (not illustrated), and a cover glass. In a side surface of the case main body, a crown 9 is provided at a 3 o'clock position (right side in FIG. 1). The crown 9 is for operating the movement 3 from an outside of the case main body. The crown 9 is fixed to a winding stem 10 inserted into the case main body.

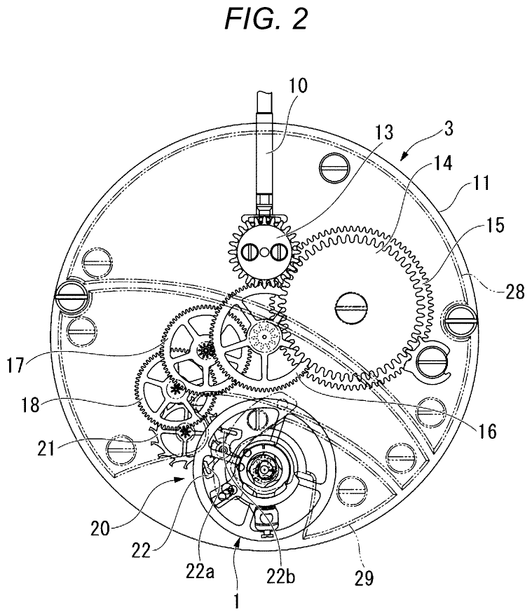

FIG. 2 is a plan view of the movement 3 according to the first embodiment when viewed from a front side.

As illustrated in FIG. 2, the movement 3 is implemented such that a plurality of gear bodies and the like are rotatably supported by a main plate 11 constituting a base of the movement 3. In the following description, a cover glass side (a dial 4 side) of the timepiece case 8 with respect to the main plate 11 is referred to as a “back side” of the movement 3, and a case lid side (a side opposite to the dial 4 side) is referred to as a “front side” of the movement 3. Each of the gear bodies described below is provided with front and back surface directions of the movement 3 as an axial direction.

The winding stem 10 described above is incorporated in the main plate 11. The winding stem 10 is used to correct a date and time. The winding stem 10 is rotatable about its axis and movable in the axial direction. A position of the winding stem 10 in the axis direction is determined by a switching device (not illustrated). When the winding stem 10 is rotated, a crown wheel 13 and a ratchet wheel 14 are sequentially rotated via rotation of a clutch wheel and a winding pinion (both not illustrated), and a mainspring (not illustrated) accommodated in a movement barrel complete 15 is wound up.

The movement barrel complete 15 is rotatably supported between the main plate 11 and a barrel bridge 28. When the movement barrel complete 15 rotates due to a restoring force of the mainspring, a center wheel and pinion 16, a third wheel and pinion 17, and a fourth wheel and pinion 18 sequentially rotate due to the rotation of the movement barrel complete 15. The movement barrel complete 15, the center wheel and pinion 16, the third wheel and pinion 17, and the fourth wheel and pinion 18 constitute a front train wheel.

A minute hand 6 (see FIG. 1) is attached to the center wheel and pinion 16 of the front train wheel. An hour hand 5 is attached to an hour wheel (not illustrated) that rotates with rotation of the center wheel and pinion 16. A seconds hand 7 (see FIG. 1) is configured to rotate based on rotation of the fourth wheel and pinion 18.

A speed governing escapement 20 is mounted on the movement 3. The speed governing escapement 20 includes an escape wheel and pinion 21, a pallet fork 22, and a temperature compensation-type balance with hairspring 1 (hereinafter, may be simply referred to as the balance with hairspring 1).

The escape wheel and pinion 21 is rotatably supported between the main plate 11 and a train wheel bridge. The escape wheel and pinion 21 rotates with rotation of the fourth wheel and pinion 18.

A pallet fork 22 is supported so as to be reciprocally rotatable between the main plate 11 and a pallet bridge. The pallet fork 22 includes a pair of pallet stones 22a, 22b. The pallet stones 22a and 22b alternately engage with an escape gear of the escape wheel and pinion 21 in accordance with reciprocating rotation of the pallet fork 22. The escape wheel and pinion 21 temporarily stops rotating when one pallet stone of the pair of pallet stones 22a and 22b is engaged with the escape gear. The escape wheel and pinion 21 rotates when the pair of pallet stones 22a and 22b are separated from the escape gear. By continuously repeating these operations, the escape wheel and pinion 21 intermittently rotates. The intermittent rotation of the escape wheel and pinion 21 causes the above-described train wheel (front train wheel) to operate intermittently, thereby controlling rotation of the front train wheel.

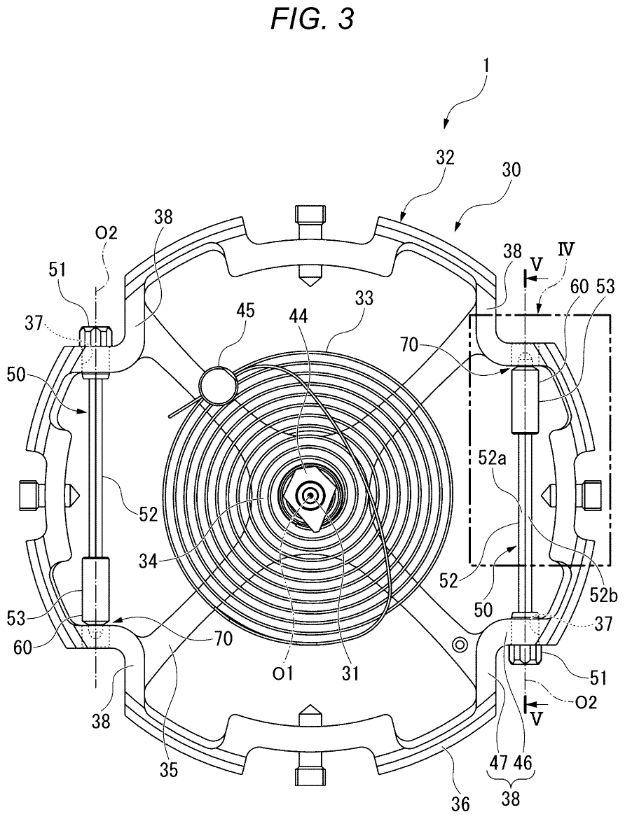

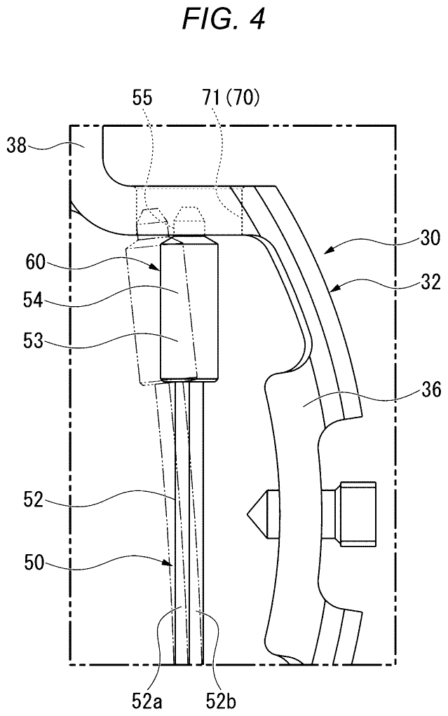

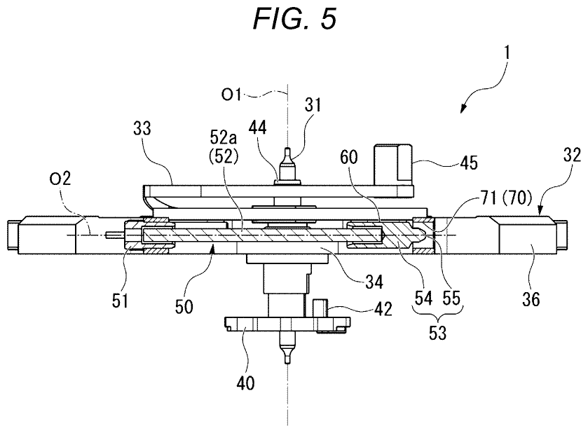

FIG. 3 is a plan view of the balance with hairspring 1 according to the first embodiment viewed from the front side. FIG. 4 is an enlarged view of a portion IV in FIG. 3. FIG. 5 is a cross-sectional view taken along line V-V in FIG. 3. In FIG. 4, some dimensions (for example, an inner diameter dimension of a free end insertion portion 71) and the like are exaggerated for description.

As illustrated in FIGS. 3 and 5, the balance with hairspring 1 controls a speed of the escape wheel and pinion 21 (allowing the escape wheel and pinion 21 to escape at a constant speed). The balance with hairspring 1 includes a balance with hairspring main body 30, adjustment portions 50, and a regulation portion 70.

The balance with hairspring main body 30 includes a balance staff 31, a balance wheel 32, and a hairspring 33.

The balance staff 31 is supported rotatably around a first axis O1 between the main plate 11 and a balance bridge 29 (see FIG. 2 for both). In the following description, a direction along the first axis O1 may be referred to as a first axis direction, a direction orthogonal to the first axis O1 may be referred to as a first radial direction, and a direction around the first axis O1 may be referred to as a first circumferential direction. In this case, the first axis direction coincides with front and back surface directions of the timepiece 2.

As illustrated in FIG. 5, the balance staff 31 rotates forward and backward around the first axis O1 at a constant vibration period by power transmitted from the hairspring 33. A front side end portion of the balance staff 31 in the first axis direction is supported by the balance bridge 29 (see FIG. 2) via a bearing (not illustrated). A back side end portion of the balance staff 31 in the first axis direction is supported by a bearing (not illustrated) formed on the main plate 11 (see FIG. 2).

A double roller 40 is externally fitted to the back side end portion of the balance staff 31 in the first axis direction. The double roller 40 is formed in a cylindrical shape disposed coaxially with the first axis O1. An impulse pin 42 is provided in a part of the first circumferential direction of the double roller 40. The impulse pin 42 repeatedly engages with and disengages from a pallet fork box of the pallet fork 22 in synchronization with reciprocating rotation of the balance with hairspring 1. Accordingly, the pallet fork 22 reciprocally rotates, and the pallet stones 22a and 22b repeatedly engage with and disengage from the escape wheel and pinion 21.

As illustrated in FIGS. 3 and 5, the balance wheel 32 is fixed to a front side of the balance staff 31 in the first axis direction with respect to the double roller 40. The balance wheel 32 mainly includes a hub portion 34, spoke portions 35, and a rim portion 36. In the present embodiment, the hub portion 34, the spoke portion 35, and the rim portion 36 are integrally formed of a metal material (for example, brass).

The hub portion 34 is fixed to the balance staff 31 by press-fitting or the like.

The spoke portion 35 extends radially outward in the first radial direction from the hub portion 34. In the present embodiment, four spoke portions 35 are provided at equal intervals in the first circumferential direction. A protruding position, the number, and the like of the spoke portions 35 can be appropriately changed.

The rim portion 36 is formed in an annular shape disposed coaxially with the first axis O1. The rim portion 36 surrounds the hub portion 34 from an outside in the first radial direction. An outer end portion of the spoke portion 35 in the first radial direction is connected to an inner circumferential surface of the rim portion 36.

The hairspring 33 is a flat hairspring having a spiral shape in a plan view viewed from the first axis direction. The hairspring 33 is wound so as to follow an Archimedes curve. An inner end portion of the hairspring 33 is connected to the balance staff 31 via a collet 44. An outer end portion of the hairspring 33 is connected to the balance bridge 29 via a stud 45. The hairspring 33 serves to store power transmitted from the fourth wheel and pinion 18 to the escape wheel and pinion 21 and transmit the power to the balance staff 31.

As a material for the hairspring 33, for example, a constant elastic material (for example, coelinvar) is suitably used. The hairspring 33 has a positive temperature characteristic in Young's modulus in a use temperature range. In this case, a temperature coefficient of the Young's modulus of the hairspring 33 is adjusted such that a vibration period of the balance with hairspring 1 is as constant as possible with respect to a temperature characteristic of a moment of inertia of the balance wheel 32 due to a temperature change. The hairspring 33 may be formed of a material other than the constant elastic material. In this case, as the hairspring 33, a general steel material having a negative temperature coefficient of Young's modulus (a characteristic in which a spring constant decreases due to a temperature rise) may be used.

As illustrated in FIG. 3, a pair of adjustment portions 50 are provided at positions rotationally symmetrical around the first axis O1 in the balance wheel 32. Each of the adjustment portions 50 is formed in a rod shape extending along a second axis O2 parallel to a tangent of the rim portion 36. The adjustment portion 50 is supported by a support portion 38 formed integrally with the rim portion 36. Since configurations of the adjustment portions 50 and the support portions 38 are equivalent to each other, in the following description, one adjustment portion 50 (the adjustment portion 50 on a right side in FIG. 3) will be described as an example. In the following description, a direction along the second axis O2 may be referred to as a second axis direction, a direction orthogonal to the second axis O2 may be referred to as a second radial direction, and a direction around the second axis O2 may be referred to as a second circumferential direction.

The support portion 38 is formed by a portion of the rim portion 36 bulging inward in the first radial direction. More specifically, when viewed from the first axis direction, the support portion 38 is formed in an L shape by a first column portion 46 extending to an inside of the rim portion 36 along the direction orthogonal to the second axis O2 and a second column portion 47 extending to the inside of the rim portion 36 along a direction parallel to the second axis O2. In the present embodiment, a total of four such support portions 38 are provided, and one adjustment portion 50 is provided between two adjacent support portions 38. The other adjustment portion 50 is provided between the remaining two support portions 38. The first column portion 46 of the support portion 38 is formed with an attachment hole 37 (through hole) penetrating the support portion 38 along the second axis direction. The attachment hole 37 is formed in a circular shape when viewed from the second axis direction.

The adjustment portion 50 is supported by the support portion 38 in a cantilever manner inside the rim portion 36. Specifically, the adjustment portion 50 is formed by connecting a fixing portion 51, a bimetal portion 52, and a weight 53 from a base end side (fixed end side) to a tip end side (a free end 60 side) in the second axis direction.

The fixing portion 51 is formed of, for example, a metal material. The fixing portion 51 is formed in a circular shape when viewed from the second axis direction corresponding to the attachment hole 37 described above. The fixing portion 51 is press-fitted (elastically held) into the above-described attachment hole 37.

An interference between the fixing portion 51 and the attachment hole 37 is set to such an extent that the adjustment portion 50 can rotate around the second axis O2 when a predetermined torque is applied to the adjustment portion 50 around the second axis O2 (second circumferential direction). That is, the adjustment portion 50 in the present embodiment is able to adjust a position around the second axis O2 by rotating around the second axis O2 while an outer circumferential surface of the fixing portion 51 slides along an inner circumferential surface of the attachment hole 37.

The bimetal portion 52 is joined (for example, welded or adhered) to a tip surface of the fixing portion 51 in the second axis direction. The bimetal portion 52 is formed in a plate shape extending in a straight line shape along the second axis direction on an inner side of the rim portion 36 in the first radial direction. The bimetal portion 52 is formed by stacking two plates (a low expansion member 52a and a high expansion member 52b) having different thermal expansion coefficients in the second radial direction. In the present embodiment, the low expansion member 52a is made of Invar (Ni—Fe alloy), silicon, ceramic, or the like. Copper, a copper alloy, aluminum, or the like is used for the high expansion member 52b. The low expansion member 52a and the high expansion member 52b are formed in the same shape (a cross-sectional shape orthogonal to the second axis O2 is rectangular). In the illustrated example, a boundary portion between the low expansion member 52a and the high expansion member 52b is located on the second axis O2. It is preferable that the center of gravity of each adjustment portion 50 is located on the second axis O2. Therefore, a plate thicknesses of the low expansion member 52a and the high expansion member 52b may be different from each other. When the low expansion member 52a and the high expansion member 52b have different plate thicknesses, the boundary portion between the low expansion member 52a and the high expansion member 52b extends parallel to the second axis O2.

An orientation of the bimetal portion 52 (the low expansion member 52a and the high expansion member 52b) in the second radial direction can be changed as the adjustment portion 50 rotates around the second axis O2. The bimetal portion 52 is deformable in the second radial direction with a temperature change by using a difference in thermal expansion coefficient between the low expansion member 52a and the high expansion member 52b.

As illustrated in FIGS. 3 and 4, the weight 53 is joined (for example, welded or adhered) to a tip surface of the bimetal portion 52 in the second axis direction. The weight 53 is formed of, for example, a metal material. As illustrated in FIG. 4, the weight 53 includes a main body portion 54 attached to the bimetal portion 52 and a tip portion 55 provided on the free end 60 side relative to the main body portion 54. The main body portion 54 of the weight 53 has a circular cross-sectional shape orthogonal to the second axis O2. When viewed from the second axis direction, an outer diameter of the main body portion 54 of the weight 53 is larger than an outer diameter of the bimetal portion 52.

The tip portion 55 of the weight 53 is formed integrally with the main body portion 54. The tip portion 55 has a circular cross-sectional shape orthogonal to the second axis O2. An outer diameter of the tip portion 55 is smaller than the outer diameter of the main body portion 54. The “free end 60 of the adjustment portion 50” in the claims includes the tip portion 55 of the weight 53. The tip portion 55 of the weight 53 is loosely inserted into the free end insertion portion 71 (regulation portion 70) formed in the support portion 38 of the rim portion 36.

Next, a method of adjusting a temperature coefficient correction amount by the adjustment portion 50 described above will be described with reference to FIG. 4. In a state in FIG. 4, in the bimetal portion 52, the low expansion member 52a and the high expansion member 52b are arranged in the first radial direction in a state where the low expansion member 52a is located on an inner side in the first radial direction.

As illustrated in FIG. 4, in the balance with hairspring 1 in the present embodiment, when a temperature change occurs, the bimetal portion 52 is bent and deformed due to a difference in thermal expansion coefficient between the low expansion member 52a and the high expansion member 52b. Specifically, when the temperature rises with respect to a predetermined temperature T0 (room temperature (for example, about 23° C.)), the high expansion member 52b expands more than the low expansion member 52a. Accordingly, the adjustment portion 50 is deformed to one side (the inner side in the first radial direction in FIG. 4) in a stacking direction of the low expansion member 52a and the high expansion member 52b (see a two-dot chain line in the drawing). Meanwhile, when the temperature decreases with respect to the predetermined temperature T0, the high expansion member 52b contracts more than the low expansion member 52a. Accordingly, the adjustment portion 50 is deformed to the other side in the stacking direction (an outer side in the first radial direction in FIG. 4).

The deformation of the adjustment portion 50 changes a distance in the first radial direction between the tip portion 55 (free end 60) of the adjustment portion 50 and the first axis O1. Specifically, when the temperature rises, the distance between the tip portion 55 of the adjustment portion 50 and the first axis O1 decreases, and when the temperature decreases, the distance between the tip portion 55 of the adjustment portion 50 and the first axis O1 increases. An average diameter of the balance wheel 32 can be reduced or increased according to a change amount of the distance, and a moment of inertia of the balance with hairspring 1 around the first axis O1 can be changed. That is, when the temperature rises, the average diameter of the balance wheel 32 can be reduced to reduce the moment of inertia. When the temperature decreases, the average diameter of the balance wheel 32 can be increased to increase the moment of inertia. Accordingly, a temperature coefficient of the moment of inertia can be corrected.

As in the present embodiment, when a constant elastic material is used for the hairspring 33, the temperature coefficient of the Young's modulus may fluctuate positively or negatively depending on a processing condition in a manufacturing process (for example, melting or heat treatment) of the hairspring 33. When a rate has a negative temperature characteristic, the rate tends to slow down as the temperature rises. When the rate has a positive temperature characteristic, the rate tends to increase as the temperature rises.

Meanwhile, in the present embodiment, an orientation (rotation angle around the second axis O2) of the bimetal portion 52 can be changed according to the temperature coefficient of the Young's modulus of the hairspring 33. In other words, the stacking direction of the low expansion member 52a and the high expansion member 52b in the bimetal portion 52 can be changed.

For example, a position of the adjustment portion 50 when the stacking direction of the low expansion member 52a and the high expansion member 52b coincides with a front-back direction of the balance with hairspring 1 is set as a reference position. When the adjustment portion 50 is at the reference position, the bimetal portion 52 deforms only along the first axis direction. Therefore, at the reference position, since the change amount in the distance between the tip portion 55 of the adjustment portion 50 and the first axis O1 is 0, the temperature coefficient of the moment of inertia does not change.

When the orientation of the bimetal portion 52 is rotated such that the low expansion member 52a is located inside the high expansion member 52b in the first radial direction with respect to the reference position, as described above, the tip portion 55 of the adjustment portion 50 approaches the first axis O1 when the temperature rises, so that the moment of inertia can be reduced as compared with that in the reference position. An amount of decrease in the moment of inertia can be finely adjusted by adjusting an amount of rotation of the bimetal portion 52 with respect to the reference position.

Meanwhile, when the orientation of the bimetal portion 52 is rotated such that the low expansion member 52a is located outside the high expansion member 52b in the first radial direction with respect to the reference position, the tip portion 55 of the adjustment portion 50 moves away from the first axis O1 when the temperature rises, so that the moment of inertia can be increased as compared with that in the reference position. An amount of increase in the moment of inertia can be finely adjusted by adjusting an amount of rotation of the bimetal portion 52 with respect to the reference position.

Therefore, when the rate has a negative temperature characteristic, the bimetal portion 52 of the adjustment portion 50 is rotated such that the low expansion member 52a is located inside the high expansion member 52b in the first radial direction. Accordingly, since the temperature coefficient of the moment of inertia can be reduced by securing a change amount of radius to the inner side in the first radial direction according to the temperature rise, it is possible to reduce an increase in the moment of inertia of the balance with hairspring 1 according to the temperature rise. As a result, the temperature coefficient of the vibration period of the balance with hairspring 1 is adjusted to approach zero, and the rate is maintained constant regardless of the temperature change.

When the rate has a positive temperature characteristic, the bimetal portion 52 of the adjustment portion 50 is rotated such that the low expansion member 52a is located outside the high expansion member 52b in the first radial direction. Accordingly, since the temperature coefficient of the moment of inertia can be increased by securing a change amount of radial to the outer side in the first radial direction according to the temperature rise, it is possible to increase an amount of increase in the moment of inertia of the balance with hairspring 1 according to the temperature rise. As a result, the temperature coefficient of the vibration period of the balance with hairspring 1 is adjusted to approach zero, and the rate is maintained constant regardless of the temperature change.

In this way, the temperature coefficient of the moment of inertia of the balance with hairspring 1 can be corrected to both positive and negative by changing a rotation angle of the adjustment portion 50 (a rotation angle of the bimetal portion 52) according to the temperature characteristic of the rate. Accordingly, a variation in the temperature coefficient of the Young's modulus is easily canceled by a temperature characteristic of a moment of inertia of the balance with hairspring 1.

Returning to FIGS. 3 and 4, the regulation portion 70 is provided at a position corresponding to the free end 60 of the adjustment portion 50 (that is, the tip portion 55 of the weight 53) in the rim portion 36 (support portion 38). The regulation portion 70 regulates movement of the adjustment portion 50 so that the free end 60 of the adjustment portion 50 does not move beyond a predetermined range. As described above, in the present embodiment, the regulation portion 70 is the free end insertion portion 71 which is formed in the rim portion 36 and into which the free end 60 of the adjustment portion 50 is inserted. The free end insertion portion 71 is a hole penetrating the support portion 38 along the second axis direction. The inner diameter dimension of the free end insertion portion 71 (hole) is larger than an outer diameter of the tip portion 55 of the weight 53. In the present embodiment, the inner diameter dimension of the free end insertion portion 71 is equal to an inner diameter dimension of the attachment hole 37.

The inner diameter dimension of the free end insertion portion 71 is set to have a gap of 0 mm or more relative to a movement range of the bimetal portion 52 at a predetermined use temperature (for example, 8° C. to 38° C.) of the balance with hairspring 1.

As an example, the free end insertion portion 71 has the inner diameter dimension having a size equivalent to a movement range of the bimetal portion 52 in a temperature range (for example, 0° C. to 50° C.) wider than the predetermined use temperature of the balance with hairspring 1. Alternatively, the free end insertion portion 71 may have a gap having a size corresponding to a temperature change of X degrees (X≥0) exceeding the predetermined use temperature of the balance with hairspring 1. X is preferably set in a range of 0 degrees≤X degrees≤30 degrees.

As another example, the free end insertion portion 71 may have a gap of 0 mm or more and 0.1 mm or less relative to the movement range of the bimetal portion 52 at the predetermined use temperature (for example, 8° C. to 38° C.) of the balance with hairspring 1. Preferably, the free end insertion portion 71 may have a gap of 0.01 mm or more and 0.1 mm or less relative to the movement range of the bimetal portion 52. More preferably, the free end insertion portion 71 may have a gap of 0.02 mm or more and 0.05 mm or less relative to the movement range of the bimetal portion 52.

### (Operation and Effect)

Next, the operation and effect of the temperature compensation-type balance with hairspring 1 will be described.

The temperature compensation-type balance with hairspring 1 in the present embodiment includes the balance with hairspring main body 30 that rotates around the first axis O1, the adjustment portion 50 that is supported as a cantilever along the second axis O2 and includes the bimetal portion 52, and the regulation portion 70 that is provided at a position corresponding to the free end 60 of the adjustment portion 50 and regulates movement of the adjustment portion 50. According to this configuration, the bimetal portion 52 of the adjustment portion 50 is deformed according to a temperature change, and thus the average diameter of the balance with hairspring main body 30 is changed. Accordingly, the temperature characteristic of the moment of inertia can be corrected. As a result, the vibration period of the balance with hairspring 1 can be kept constant, and the balance with hairspring 1 having an excellent temperature compensation characteristic can be obtained. Since the adjustment portion 50 extends in a cantilever manner, a deformation amount in the radial direction due to a temperature change can be secured, and a temperature correction amount by the bimetal portion 52 can be increased.

The regulation portion 70 is provided at a position corresponding to the free end 60 of the adjustment portion 50. Accordingly, even when an impact is applied to the balance with hairspring 1 due to falling or the like, since the movement of the free end 60 of the adjustment portion 50 is limited by the regulation portion 70, it is possible to reduce deformation of the bimetal portion 52. As a result, as compared with the related art, it is possible to perform correct temperature compensation even when an impact is applied, and to reduce a rate shift of the timepiece 2. Since it is not necessary to reduce a weight of the weight 53 as a countermeasure against an impact, there is no restriction on the weight of the weight 53, and a large temperature correction amount can be secured. Further, since it is not necessary to increase strength of the bimetal portion 52 as a countermeasure against an impact, restrictions (Young's modulus, allowable stress, and the like) on a bimetal material are reduced, and a degree of freedom in material selection can be improved. In other words, design can be performed in consideration of only an expansion coefficient. Therefore, it is possible to provide highly accurate temperature compensation performance. Since a weight of the balance with hairspring is reduced as compared with the case where the strength of the bimetal portion 52 is increased, it is possible to reduce occurrence of difference in rate between horizontal and vertical positions.

Therefore, it is possible to provide the temperature compensation-type balance with hairspring 1 capable of reducing deformation of the bimetal portion 52 and improving the temperature compensation performance.

The balance with hairspring main body 30 includes the balance staff 31 and the balance wheel 32. The second axis O2 is a straight line located inside the rim portion 36 and parallel to a tangential direction of the rim portion 36 in a plan view viewed from the first axis O1. The adjustment portion 50 extends from the rim portion 36. According to this configuration, since the adjustment portion 50 is provided on the rim portion 36 of the balance wheel 32, the adjustment portion 50 can be separated from the first axis O1 in the radial direction. Accordingly, it is possible to increase the deformation amount of the adjustment portion 50 along the radial direction, and it is possible to increase the temperature coefficient correction amount by the bimetal portion 52. Since the second axis O2 is located inside the rim portion 36, it is possible to secure the deformation amount along the radial direction due to the temperature change while reducing an increase in size of the balance with hairspring 1 due to addition of the adjustment portion 50.

The regulation portion 70 is formed along the second axis O2 in the rim portion 36, and includes the free end insertion portion 71 into which the free end 60 of the adjustment portion 50 is inserted. According to this configuration, since the regulation portion 70 is provided in the rim portion 36, it is possible to reduce an increase in the number of components and an increase in the weight of the balance with hairspring 1 due to provision of the regulation portion 70. Movement of the free end 60 of the adjustment portion 50 can be regulated by inserting the free end 60 of the adjustment portion 50 into the free end insertion portion 71 formed in the rim portion 36. Therefore, deformation of the adjustment portion 50 at the time of impact can be reduced with a simple configuration.

The rim portion 36 has the attachment hole 37 for fixing one end portion of the adjustment portion 50, and is formed such that the inner diameter dimension of the attachment hole 37 and the inner diameter dimension of the free end insertion portion 71 are the same. According to this configuration, the attachment hole 37 and the free end insertion portion 71 formed in the rim portion 36 can be simultaneously formed. Alternatively, the attachment hole 37 and the free end insertion portion 71 can be formed by the same tool. Therefore, workability at the time of manufacturing can be improved.

The adjustment portion 50 includes the weight 53 attached to the free end 60 side of the bimetal portion 52. The weight 53 includes the main body portion 54 attached to the bimetal portion 52 and the tip portion 55 having an outer diameter dimension smaller than an outer diameter dimension of the main body portion 54. The tip portion 55 of the weight 53 is inserted into the free end insertion portion 71 of the regulation portion 70. According to this configuration, since a weight of the adjustment portion 50 can be increased by providing the weight 53, the temperature correction amount by the bimetal portion 52 can be increased. Since the tip portion 55 of the weight 53 having a small outer diameter dimension is inserted into the free end insertion portion 71, the inner diameter dimension of the free end insertion portion 71 can be reduced. Therefore, particularly when the free end insertion portion 71 is formed in the rim portion 36, it is possible to achieve excellent temperature compensation performance while reducing a decrease in strength of the rim portion 36.

The regulation portion 70 has a gap having a size corresponding to a predetermined temperature change of 0° C. or higher and 30° C. or lower with respect to a predetermined use temperature. Alternatively, the gap has a size of 0 mm or more and 0.1 mm or less with respect to the movement range of the bimetal portion 52 at the predetermined use temperature. According to this configuration, the size of the gap can be appropriately set with respect to a swing width of the adjustment portion 50 at an assumed use temperature. Therefore, it is possible to effectively achieve temperature compensation performance while reducing deformation when an impact occurs.

The movement 3 and the timepiece 2 in the present embodiment include the temperature compensation-type balance with hairspring 1 described above. Therefore, it is possible to provide the high performance movement 3 and timepiece 2 including the temperature compensation-type balance with hairspring 1 capable of reducing deformation of the bimetal portion 52 and improving the temperature compensation performance.

### Second Embodiment

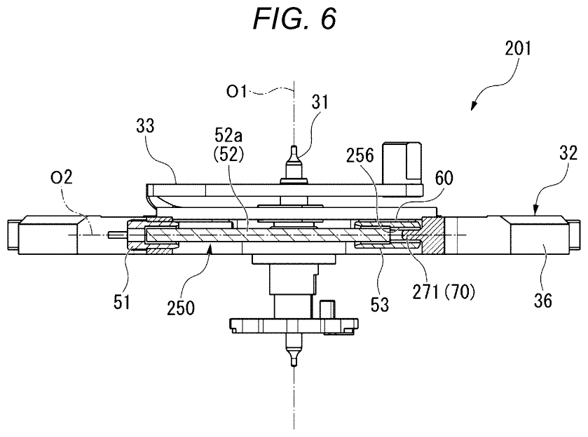

Next, second to fourth embodiments according to the invention will be described with reference to FIGS. 6 to 8. In the following description, the same configurations as those of the first embodiment described above are denoted by the same reference signs, and the description thereof will be appropriately omitted. Special configurations are not limited to these embodiments and can be appropriately changed without departing from the gist of the invention. The second to fourth embodiments are different from the first embodiment in the configuration of the regulation portion 70 or a method of regulating movement of the free end 60 of the adjustment portion 50 by the regulation portion 70.

FIG. 6 is a cross-sectional view of a balance with hairspring 201 according to the second embodiment. FIG. 6 is the cross-sectional view taken at a position corresponding to FIG. 5 in the first embodiment.

As illustrated in FIG. 6, in the second embodiment, an adjustment portion 250 has a recess 256 recessed along the second axis O2 at an end portion on the free end 60 side. The recess 256 is formed in the weight 53. The regulation portion 70 has a protrusion portion 271 inserted into the recess 256. The protrusion portion 271 protrudes from the support portion 38 along the second axis direction. That is, while the free end 60 of the adjustment portion 50 is inserted into the regulation portion 70 in the first embodiment described above, the regulation portion 70 is inserted into the free end 60 of the adjustment portion 250 in the present embodiment. A size of a gap between the protrusion portion 271 and the recess 256 may be the same size as that in the first embodiment.

According to the temperature compensation-type balance with hairspring 201 in the second embodiment, similarly to the first embodiment described above, it is possible to provide the temperature compensation-type balance with hairspring 201 capable of reducing deformation of the bimetal portion 52 at the time of impact and improving temperature compensation performance. Since the regulation portion 70 can be provided without forming a hole, a recess, or the like in the rim portion 36 of the balance with hairspring 201, it is possible to reduce a decrease in strength of the balance with hairspring 201 due to the provision of the regulation portion 70. Therefore, it is possible to reduce a decrease in strength of the balance with hairspring 201 and deformation of the bimetal portion 52 and to improve the temperature compensation performance.

### Third Embodiment

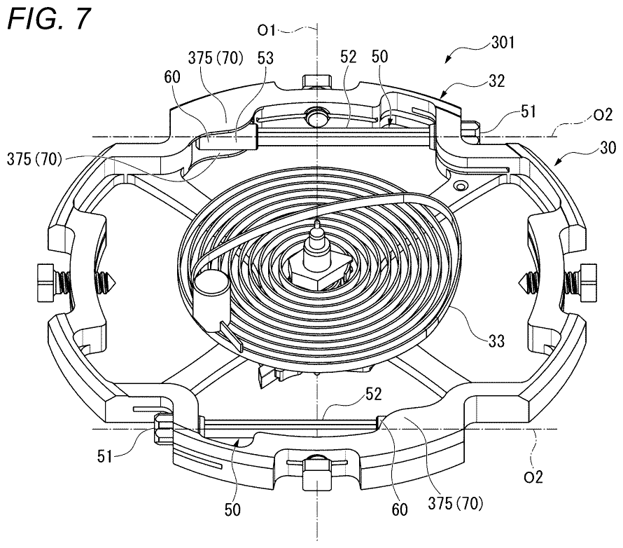

FIG. 7 is an external perspective view of a balance with hairspring 301 according to the third embodiment. As illustrated in FIG. 7, in the third embodiment, the regulation portion 70 includes a pair of wall portions 375 connected to the balance with hairspring main body 30. The pair of wall portions 375 are provided on both sides of the free end 60 in the adjustment portion 50 in the first axis direction (a vertical direction in the claim, a direction coinciding with the front-back direction of the balance with hairspring 1), and regulate (limit) a movement range of the free end 60 in the first axis direction. The pair of wall portions 375 extend along a front surface and a back surface of the balance wheel 32. The weight 53 of the adjustment portion 50 is inserted between the pair of wall portions 375.

According to the temperature compensation-type balance with hairspring 301 in the third embodiment, since movement of the free end 60 of the adjustment portion 50 in the vertical direction (a direction along an axial direction of the first axis O1) is limited by the pair of wall portions 375, deformation of the bimetal portion 52 at the time of impact can be reduced. Therefore, it is possible to provide the temperature compensation-type balance with hairspring 301 capable of reducing deformation of the bimetal portion 52 and improving the temperature compensation performance. Moreover, versatility of the regulation portion 70 can be enhanced.

### Fourth Embodiment

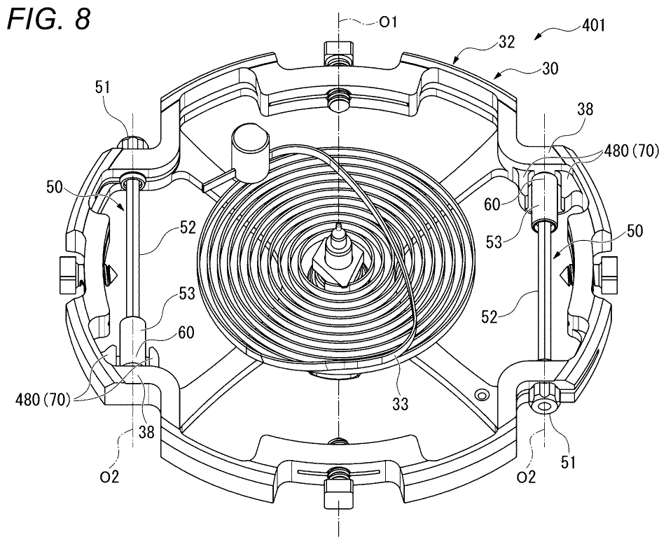

FIG. 8 is an external perspective view of a balance with hairspring 401 according to the fourth embodiment.

As illustrated in FIG. 8, in the fourth embodiment, the regulation portion 70 includes a pair of wall portions 480 connected to the balance with hairspring main body 30. The pair of wall portions 480 are provided on both sides of the free end 60 of the adjustment portion 50 in the first radial direction, and regulate (limit) a movement range of the free end 60 in the first radial direction. The pair of wall portions 480 protrude from the support portion 38 of the balance wheel 32 toward an inside of the balance wheel 32 in the second axis direction. The weight 53 of the adjustment portion 50 is inserted between the pair of wall portions 480.

According to the temperature compensation-type balance with hairspring 401 in the fourth embodiment, since movement of the free end 60 of the adjustment portion 50 in a left-right direction (a direction along a radial direction of the first axis O1) is limited by the pair of wall portions 480, deformation of the bimetal portion 52 at the time of impact can be reduced. Therefore, it is possible to provide the temperature compensation-type balance with hairspring 401 capable of reducing deformation of the bimetal portion 52 and improving the temperature compensation performance. Moreover, versatility of the regulation portion 70 can be enhanced.

### Fifth Embodiment

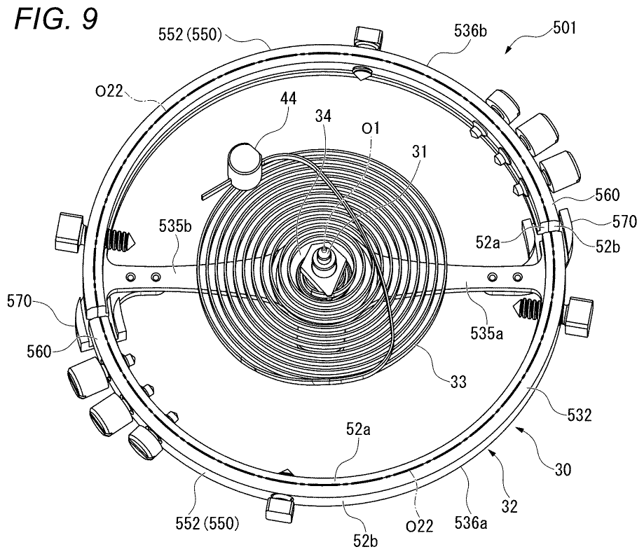

Next, the fifth embodiment according to the invention will be described. In the following description, the same configurations as those of the first embodiment described above are denoted by the same reference signs, and the description thereof will be appropriately omitted. FIG. 9 is an external perspective view of a balance with hairspring 501 according to the fifth embodiment. The fifth embodiment is different from the first embodiment in that a bimetal portion 552 is formed in a rim shape.

As illustrated in FIG. 9, in the fifth embodiment, the balance with hairspring main body 30 includes the balance staff 31, a pair of spoke portions 535a and 535b extending from the balance staff 31 along the first radial direction, and a pair of rim portions 536a and 536b surrounding the balance staff 31 from an outside of the first axis O1 in the radial direction. Each of the rim portions 536a and 536b is formed in a semicircular arc shape when viewed from the first axis direction. The pair of spoke portions 535a and 535b are provided at intervals of 180° in the first circumferential direction. One end portion of one rim portion 536a is connected to an outer diameter side end portion of one of the pair of spoke portions 535a and 535b, the spoke portion 535a. One end portion of the other rim portion 536b is connected to an outer diameter side end portion of the other of the pair of spoke portions 535a and 535b, the spoke portion 535b. Therefore, each of the rim portions 536a and 536b has a cantilever structure in which the one end portion connected to the corresponding one of the spoke portions 535a and 535b is supported.

In the present embodiment, the entire rim portions 536a and 536b are the bimetal portion 552. In other words, a second axis O22, which is an extending direction of the bimetal portion 552 in the claims, is an arc-shaped curve along the rim portions 536a and 536b. The rim portions 536a and 536b (bimetal portion 552) are formed by stacking the low expansion member 52a located on an inner side in the first radial direction and the high expansion member 52b located on an outer side in the first radial direction on each other in the first radial direction.

In the balance with hairspring 501 formed in this manner, when a temperature change occurs, the rim portions 536a and 536b (bimetal portion 552) are bent and deformed due to a difference in thermal expansion coefficient between the low expansion member 52a and the high expansion member 52b. Specifically, when the temperature rises with respect to the predetermined temperature T0, the high expansion member 52b expands more than the low expansion member 52a. Accordingly, a free end 560 of the rim portion 536a, 536b (bimetal portion 552) is deformed inward in the first radial direction. As a result, an average diameter of a balance wheel 532 can be reduced to reduce a moment of inertia.

Meanwhile, when the temperature decreases with respect to the predetermined temperature T0, the high expansion member 52b contracts more than the low expansion member 52a. Accordingly, the free end 560 of the rim portion 536a, 536b (bimetal portion 552) is deformed outward in the first radial direction. As a result, the average diameter of the balance wheel 532 can be increased to increase the moment of inertia.

A regulation portion 570 is attached to each of the pair of spoke portions 535a and 535b. Specifically, the regulation portion 570 that regulates a movement range of the free end 560 of the other rim portion 536b (bimetal portion 552) is provided on the one of the pair of the spoke portions 535a and 535b, the spoke portion 535a. The regulation portion 570 that regulates the movement range of the free end 560 of the one rim portion 536a (bimetal portion 552) is provided on the other of the pair of spoke portions 535a and 535b, the spoke portion 535b. Each regulation portion 570 is provided at a position corresponding to the free end 560 of the rim portion 536a, 536b (bimetal portion 552), and has a wall portion on the inner side and the outer side in the first radial direction with respect to the free end 560. Accordingly, the regulation portion 570 regulates the movement of the free end 560 of the rim portion 536a, 536b (bimetal portion 552) in the first radial direction.

As in the first embodiment, the weight 53 (see FIG. 3) may be provided near the free end 560 of the rim portion 536a, 536b (bimetal portion 552).

According to the temperature compensation-type balance with hairspring 501 in the fifth embodiment, since the rim portions 536a and 536b and the bimetal portion 552 (adjustment portion 550) are integrated, a simpler configuration can be obtained. Not only the bar type bimetal portion 52 as in the first embodiment described above but also the rim type bimetal portion 552 can achieve the same operation and effect as in the first embodiment, and thus versatility of the temperature compensation-type balance with hairspring 501 can be improved.

Further, even when an impact is applied to the balance with hairspring 501 due to falling or the like, since the movement of the free end 560 of the adjustment portion 550 is limited by the regulation portion 570, it is possible to reduce deformation of the bimetal portion 552. Therefore, it is possible to perform correct temperature compensation even when an impact is applied, and to reduce a rate shift of the timepiece 2. Therefore, it is possible to provide the temperature compensation-type balance with hairspring 501 capable of reducing deformation of the bimetal portion 552 and improving the temperature compensation performance.

The technical scope of the invention is not limited to the embodiments described above, and various modifications can be made without departing from the spirit of the invention.

For example, in the above-described embodiment, a configuration in which two adjustment portions 50 are provided at rotationally symmetrical positions of the rim portion 36 has been described, but the invention is not limited to this configuration. That is, as long as the adjustment portion 50 is provided at a rotationally symmetrical position, three or more adjustment portions 50 may be provided. In this case, it is preferable to provide the same number of regulation portions 70 as the adjustment portions 50.

In the above-described embodiments, a case where the regulation portion 70 is the hole (or recess) 71, a case where the regulation portion 70 is the protrusion portion 271, a case where the regulation portion 70 is the pair of wall portions 375, 480, and the like have been described, but a shape of the regulation portion 70 is not limited to a shape in the above-described embodiments. That is, the number of directions to be limited and orientations may be changed as appropriate as long as at least a movement range of the adjustment portion 50 is regulated.

A shape of the attachment hole 37 formed in the rim portion 36 is not limited to a circular shape, and may be a rectangular shape, a triangular shape, or the like. An aspect of the present embodiment in which the attachment hole 37 is formed in a circular shape similar to the free end insertion portion 71 is advantageous in that workability can be improved by forming the attachment hole 37 in a circular shape and making the inner diameter dimension of the attachment hole 37 and the inner diameter dimension of the free end insertion portion 71 equal to each other.

The weight 53 may be detachably attached to the bimetal portion 52.

A shape of the weight 53, a shape of the support portion 38 (rim portion 36), materials of the low expansion member 52a and the high expansion member 52b in the bimetal portion 52, and the like are not limited to shapes or materials in the above-described embodiments.

Components in the embodiments described above can be appropriately replaced with well-known components without departing from the gist of the invention, and the embodiments described above may be appropriately combined.

What is claimed is:

1. A temperature compensation-type balance with hairspring comprising:
a balance with hairspring main body including a balance staff extending along a first axis and rotating around the first axis by power of a hairspring;
adjustment portions that are supported as a cantilever along a second axis from rotationally symmetrical positions around the first axis in the balance with hairspring main body, each of the adjustment portions including a bimetal portion in which materials having different thermal expansion coefficients are stacked in a direction intersecting the second axis; and
a regulation portion that is provided at a position corresponding to a free end of the adjustment portion and regulates movement of the adjustment portion with a gap of 0 mm or more relative to a movement range of the bimetal portion at a predetermined use temperature.

2. The temperature compensation-type balance with hairspring according to claim 1, wherein
the balance with hairspring main body includes
the balance staff, and
a balance wheel including a rim portion surrounding the balance staff from an outer side in a radial direction of the first axis and attached to the balance staff,
the second axis is a straight line intersecting the rim portion in a plan view viewed from the first axis, and
the adjustment portion extends from the rim portion to an inner side of the rim portion.

3. The temperature compensation-type balance with hairspring according to claim 2, wherein
the regulation portion includes a free end insertion portion which is formed along the second axis in the rim portion and into which the free end of the adjustment portion is inserted.

4. The temperature compensation-type balance with hairspring according to claim 3, wherein
the rim portion has an attachment hole for fixing one end portion of the adjustment portion and is formed such that an inner diameter dimension of the attachment hole and an inner diameter dimension of the free end insertion portion are the same.

5. The temperature compensation-type balance with hairspring according to claim 3, wherein
the adjustment portion includes a weight attached to a free end side of the bimetal portion,
the weight includes a main body portion attached to the bimetal portion and a tip portion having an outer diameter dimension smaller than an outer diameter dimension of the main body portion, and
the tip portion of the weight is inserted into the free end insertion portion of the regulation portion.

6. The temperature compensation-type balance with hairspring according to claim 1, wherein
the regulation portion is formed to have a gap having a size corresponding to a predetermined temperature change of 0° C. or higher and 30° C. or lower with respect to the predetermined use temperature, or to have a gap having a size of 0 mm or more and 0.1 mm or less relative to the movement range of the bimetal portion at the predetermined use temperature.

7. The temperature compensation-type balance with hairspring according to claim 1, wherein
the adjustment portion has a recess recessed along the second axis at an end portion on a free end side, and
the regulation portion includes a protrusion portion inserted into the recess.

8. The temperature compensation-type balance with hairspring according to claim 1, wherein
the regulation portion includes a pair of wall portions that are connected to the balance with hairspring main body and regulate movement of the free end in the adjustment portion in a vertical direction parallel to the first axis.

9. The temperature compensation-type balance with hairspring according to claim 1, wherein
the regulation portion includes a pair of wall portions that are connected to the balance with hairspring main body and regulate movement of the free end in the adjustment portion in a radial direction intersecting the first axis.

10. The temperature compensation-type balance with hairspring according to claim 1, wherein
the balance with hairspring main body includes
the balance staff, and
a balance wheel including a rim portion surrounding the balance staff from an outer side in a radial direction of the first axis and a spoke portion connecting the balance staff and the rim portion and extending in the radial direction,
the second axis is a curve along the rim portion, and
the rim portion is the bimetal portion.

11. The temperature compensation-type balance with hairspring according to claim 10, wherein
the regulation portion is attached to the spoke portion and regulates movement of the free end in the radial direction.

12. A movement comprising:
the temperature compensation-type balance with hairspring according to claim 1.

13. A timepiece comprising:
the movement according to claim 12.
